(19) United States
(12) Patent Application Publication
(10) Pub. No.: US 2013/0308716 A1
(43) Pub. Date: Nov. 21, 2013

(54) WIRELESS COMMUNICATION SYSTEM, RECEPTION DEVICE, AND TRANSMISSION DEVICE

(71) Applicants: Shinpei Toh, Osaka-shi (JP); Kozue Hirata, Osaka-shi (JP); Ryota Yamada, Osaka-shi (JP)

(72) Inventors: Shinpei Toh, Osaka-shi (JP); Kozue Hirata, Osaka-shi (JP); Ryota Yamada, Osaka-shi (JP)

(73) Assignee: SHARP KABUSHIKI KAISHA, Osaka-shi, Osaka (JP)

(21) Appl. No.: 13/978,954

(22) PCT Filed: Dec. 22, 2011
(86) PCT No.: PCT/JP2011/079892

§ 371 Date: Jul. 10, 2013

(30) Foreign Application Priority Data
Jan. 11, 2011 (JP) 2011-003047

(51) Int. Cl. H04B 7/04

(52) U.S. Cl. CPC H04B 7/0456
USPC 375/267

(57) ABSTRACT

A wireless communication system includes a plurality of transmission devices, each of which transmits signals resulting from precoding performed for a plurality of resources, and a reception device that receives at least one desired signal and a plurality of undesired signals, the number of which is greater than or equal to the degree of freedom that the plurality of resources have. The at least one desired signal and the plurality of undesired signals have been transmitted from the transmission devices. The plurality of resources is the unit of precoding. At least one of the plurality of transmission devices transmits signals on each of which precoding has been performed such that equivalent channel vectors of the plurality of undesired signals in the reception device are made to be orthogonal to a reception weight vector used in the reception device. The reception device estimates equivalent channel vectors of the plurality of undesired signals, calculates a reception weight vector by using the estimated equivalent channel vectors of the plurality of undesired signals, and extracts a desired signal by multiplying a reception signal received using the plurality of resources and the calculated reception weight vector together. The plurality of resources is the unit of precoding. As a result, in a system in which IA is used, the degradation of reception characteristics may be suppressed even under circumstances in which a CSI error occurs.

### TECHNICAL FIELD

The present invention relates to wireless communication technologies.

### BACKGROUND ART

The reception characteristics of terminals positioned at a cell edge in a cellular system or the reception characteristics of reception devices in wireless communication systems may be significantly degraded due to the effects of interference (undesired signals) coming from an adjacent interference source (an adjacent cell or an adjacent wireless LAN system), the wireless systems using the same frequency band and their communication possible areas overlapping each other. Such wireless communication systems are, for example, a plurality of wireless LAN systems used in rooms that are next to one another. Interference Alignment (hereinafter referred to as “IA”) has been proposed as an interference reduction method that is effective in the case where there are a plurality of transmission sources that use the same frequency band (see NPL 1 below).

When IA is used, devices on a transmission side are controlled so as to collaborate with one another such that the (vector) directions of equivalent channel vectors of interference components are brought into alignment at the time of reception, the interference components coming from a plurality of transmission devices, which are interference sources. Consequently, even in the case where the number of interference signals that have arrived at a reception device is greater than the number of interference signals that may be eliminated, a desired signal may be extracted from a reception signal. Here, a value called the degree of freedom is used as a standard for determining the number of interference signals that may be eliminated in a reception device, the degree of freedom being determined in accordance with the number of resources, examples of the resources being time resources, frequency resources, and space resources (antennas) with which the reception device may receive signals. For example, the number of space resources, that is, the number of antennas is described as an example. When a reception device has three receive antennas, two interference signals may be eliminated and one desired signal may be extracted. The degree of freedom in this case is two. In the case where the degree of freedom is large, the larger number of interference signals may be eliminated. In this way, the degree of freedom is a value determined by the number of resources used. The resources used are not limited to the above-described space resources. Even in the case where a plurality of time resources or frequency resources are used, a similar relationship is obtained.

Here, as illustrated in FIG. 1, IA will be described in detail by using an example in which a plurality of transmission devices that have a plurality of transmit antennas transmit signals to a plurality of reception devices that have a plurality of receive antennas, the signals between each of the plurality of transmit antennas and each of the plurality of receive antennas being different from one another (see NPL 2 described below). Two transmission devices 1-1 and 1-2 illustrated in FIG. 1 each have two transmit antennas; transmit antennas AT1 and 2 for the transmission device 1-1 and transmit antennas AT3 and 4 for the transmission device 1-2. Two reception devices 3-1 and 3-2 each have three receive antennas; receive antennas AT5 to 7 for the reception device 3-1 and transmit antennas AT8 to 10 for the reception device 3-2. Moreover, in FIG. 1, xᵢⱼ denotes a signal destined for a reception device i and transmitted from a transmission device j, vᵢⱼ denotes a transmission weight vector (a precoding vector), and Hᵢⱼ denotes a channel matrix between the transmission device j and the reception device i, the transmission weight vector and a signal destined for the reception device i and transmitted from the transmission device j being multiplied together. In this way, x₁₁ transmitted from the transmission device (1) 1-1 and x₁₂ transmitted from the transmission device (2) 3-2 are desired signals in the reception device 3-1. In the reception device (2) 3-2, x₂₁ transmitted from the transmission device (1) 1-1 and x₂₂ transmitted from the transmission device (2) 1-2 are desired signals. In such a case, a reception signal yᵢ received by a reception device i is expressed as follows. Note that thermal noise components added at a reception device are ignored for the sake of simplicity.

[Math. 1]

yᵢ=Hᵢᵢvᵢᵢxᵢᵢ+Hᵢⱼvᵢⱼxᵢⱼ+Hⱼᵢvⱼᵢxⱼᵢ+Hⱼⱼvⱼⱼxⱼⱼ (i≠j) (1)

As expressed by Equation (1), four signals (two desired signals and two interference signals) arrive at a reception device. Thus, in order to extract each of the desired signals from the reception signal one by one, the rest three signals need to be eliminated as interference. Thus, the degree of freedom needs to be three. However, each reception device illustrated in FIG. 1 has only three receive antennas and the degree of freedom is two. Thus, the degree of freedom is insufficient and it is impossible to extract each desired signal by eliminating interference.

Under such circumstances, when IA is applied with which the vectors of interference signals coming from transmission devices are brought into alignment, there is a relationship Hᵢᵢvⱼᵢ=kHᵢⱼvⱼⱼ between the equivalent channel vectors of the interference signals, which are the third and fourth terms of Equation (1). Here, k is an arbitrary scalar but is a value determined in accordance with the transmission power of each transmission device and the like in an actual system. Here, for the sake of simplicity of the description, k=1, that is, Hᵢᵢvⱼᵢ=Hᵢⱼvⱼⱼ. In order to achieve such a relationship, it is necessary to adjust transmission weight vectors, each of which is used in a corresponding transmission device. This may be realized, for example, by determining a transmission weight vector vⱼᵢ used in a transmission device i and then by determining a transmission weight vector vⱼ used in a transmission device j from vⱼᵢ, Hᵢⱼ⁺Hᵢᵢvⱼᵢ (⁺ represents a generalized inverse). Here, vⱼᵢ, which is determined first, is an arbitrary vector and may be set to a vector, for example, such as vⱼᵢ=[1 1]^{T}. Moreover, the order in which the transmission weight vectors vⱼᵢ and are determined may be reversed. Note that it is necessary to perform setting such that two transmission weight vectors used in one transmission device are not parallel with each other (such that the inner product is not zero. For example, vᵢᵢ≠avⱼᵢ (a is an arbitrary scalar).)

In this way, in the case where the equivalent channel vectors of interference signals are brought into alignment at the time of reception, Equation (1) is changed to the following equation.

[Math. 2]

yᵢ=Hᵢᵢvᵢᵢxᵢᵢ+Hᵢⱼvᵢⱼxᵢⱼ+Hⱼᵢvⱼᵢ(xⱼᵢ+xᵢᵢ) (2)

Equation (2) indicates that two desired signals and one interference signal are received. Thus, it is understood that each reception device may extract each desired signal in accordance with the degree of freedom (here, two) of the reception device.

For each desired signal, a reception signal like this and a reception weight vector for extracting the desired signal are multiplied together in a reception device. Here, reception weight vectors uᵢᵢ and uᵢⱼ for completely eliminating interference and extracting desired signals xᵢᵢ and xᵢⱼ, respectively, satisfy the following equation.

[Math. 3]

uᵢᵢ[HᵢⱼvᵢⱼHᵢᵢvⱼᵢ]=0

uᵢⱼ[HᵢᵢvᵢᵢHᵢᵢvⱼᵢ]=0 (3)

In Equation (3), for example, the first equation indicates that the reception weight vector uᵢᵢ is a vector orthogonal to the vectors Hᵢⱼvᵢⱼ and Hᵢᵢvⱼᵢ. Such a vector, the vector uᵢᵢ, is the complex conjugate transpose of a right-singular vector corresponding to a singular value that is zero from among right-singular vectors obtained by performing singular value decomposition (SVD: Singular Value Decomposition) on a matrix [HᵢⱼvᵢⱼHᵢᵢvⱼᵢ]^{H}. That is, uᵢᵢ may be obtained from uᵢᵢ=e₂^{H} by using e₂ of Equation (4). Note that F and E are unitary matrices and D is a diagonal matrix with nonnegative real numbers on the diagonal.

[Math. 4]

[Hᵢⱼvᵢᵢvⱼᵢ]^{H}FDE^{H}=FD[e₁e₂]^{H} (4)

Similarly to uᵢᵢ, uᵢⱼ may be determined to be the complex conjugate transpose of a right-singular vector corresponding to a singular value that is zero from among right-singular vectors obtained by performing SVD on a matrix [Hᵢᵢvᵢᵢ Hᵢᵢvⱼᵢ]^{H}.

In the case where the above-described transmission weight vectors are used, Equation (2) is changed to Equation (5). Each of the desired signals xᵢᵢ and xᵢⱼ may be extracted while completely eliminating interference.

[Math. 5]

uᵢᵢyᵢ=uᵢᵢHᵢᵢvᵢᵢxᵢᵢ+uᵢᵢHᵢⱼvᵢⱼxᵢⱼ+uᵢⱼHᵢᵢvⱼᵢ(xⱼᵢ+xⱼⱼ)=uᵢᵢHᵢᵢvᵢᵢxᵢᵢ

uᵢⱼyᵢ=uᵢⱼHᵢᵢvᵢᵢxᵢᵢ+uᵢⱼHᵢⱼVᵢⱼxᵢⱼ+uᵢⱼHᵢᵢvⱼᵢ(xⱼᵢ+xⱼⱼ)=uᵢⱼHᵢⱼvᵢⱼxᵢⱼ (5)

In this way, even in the case where the number of interference signals that have arrived at a reception device is greater than the number of interference signals that may be eliminated, desired signals may be extracted from a reception signal by applying IA with which the vectors of interference signals coming from transmission devices are brought into alignment. That is, IA makes it possible to perform transmission while making the most use of the degree of freedom.

### CITATION LIST

### Non Patent Literature

NPL 1: “Interference Alignment and Spatial Degree of Freedom for the K User Interference Channel”, IEEE ICC, May 2008.
NPL 2: “Study on Transmission and Reception Weights for Interference Alignment in Multiple-base-station Cooperation MIMO”; the Institute of Electronics, Information, and Communication Engineers; IEICE technical report; RCS2009-291; March 2010.

### SUMMARY OF INVENTION

### Technical Problem

In the case where IA is used, it is necessary to feed back channel information (CSI: Channel State Information) obtained in a reception device to a transmission device and to determine a transmission weight vector in accordance with the CSI that has been fed back. However, in the case where a reception device or a transmission device moves or in an environment in which objects around a reception device or a transmission device move, changes may occur in channels between the time when a reception device performed estimation and the time when signals are transmitted using a transmission weight vector (a CSI error occurs). The channel matrix obtained at the time when CSI estimation is performed is denoted by H. For example, as described above, it is assumed that Hᵢᵢvⱼᵢ=kHᵢⱼvⱼⱼ (k is an arbitrary scalar) are vectors (equivalent channel vectors) of interference signals that are brought into alignment by using IA. In this case, even in the case where the channel matrices obtained at the time of CSI estimation are changed to channel matrices H′ at the time of data transmission, when Hᵢᵢ′vⱼᵢ=kHᵢⱼ′vⱼⱼ is satisfied, the vectors of interference signals are brought into alignment. Thus, interference may be completely eliminated by using existing reception weight vectors. That is, as expressed by Equation (3), the complex conjugate transpose of a right-singular vector corresponding to a singular value that is zero should be used from among right-singular vectors obtained by performing SVD on [Hᵢⱼ′vᵢⱼ Hᵢᵢ′vⱼᵢ] ^{H}.

However, in general, changes in channels are independent of one another, it is almost impossible that Hᵢᵢ′vⱼᵢ=kHᵢⱼ′vⱼⱼ is satisfied. In such a case, the vectors of interference signals are not brought into alignment at the time of reception. Thus, it is impossible to eliminate interference even when Equation (3) or the above-described reception weight vectors are used, and there is an issue in that the reception characteristics are significantly degraded. Such a CSI error occurs not only due to changes in channels but also due to a CSI-estimation error caused by the effects of thermal noise added at a reception device, a quantization error that occurs when quantization is performed for feedback, or the like. In any of the cases, the reception characteristics are degraded.

It is an object of the present invention to suppress degradation of the reception characteristics in a system that uses IA even under the circumstances in which a CSI error occurs.

### Solution to Problem

The present invention is a wireless communication system including a plurality of transmission devices, each of which transmits signals resulting from precoding performed for a plurality of resources, and a reception device that receives at least one desired signal and a plurality of undesired signals, the number of which is greater than or equal to the degree of freedom that the plurality of resources have. The at least one desired signal and the plurality of undesired signals have been transmitted from the transmission devices. The plurality of resources is the unit of precoding. At least one of the plurality of transmission devices transmits signals on each of which precoding has been performed such that equivalent channel vectors of the plurality of undesired signals in the reception device are made to be orthogonal to a reception weight vector used in the reception device. The reception device estimates equivalent channel vectors of the plurality of undesired signals, calculates a reception weight vector by using the estimated equivalent channel vectors of the plurality of undesired signals, and extracts a desired signal by multiplying a reception signal received using the plurality of resources and the calculated reception weight vector together. The plurality of resources is the unit of precoding.

A desired signal is extracted by multiplying a reception data signal and a reception weight vector as described above together. Thus, the degradation of characteristics due to the effects of a CSI error may be reduced even in the case where a CSI error occurs in a system in which IA is used. Note that, the present invention may be applied not only to IA performed using a plurality of space resources but also to IA performed using a plurality of time resources or frequency resources.

In addition, the present invention is a reception device to which signals are transmitted, each of which results from precoding performed for a plurality of resources in at least a part of a plurality of transmission devices such that equivalent channel vectors of undesired signals in the reception device are made to be orthogonal to a reception weight vector used in the reception device, and that receives at least one desired signal and a plurality of undesired signal, the number of which is greater than or equal to the degree of freedom that the plurality of resources have. The plurality of resources is the unit of precoding. Equivalent channel vectors of the plurality of undesired signals are estimated, a reception weight vector is calculated by using the estimated equivalent channel vectors of the plurality of undesired signals, and a desired signal is extracted by multiplying a reception signal received using the plurality of resources and the calculated reception weight vector together. The plurality of resources is the unit of precoding.

In addition, the present invention is a transmission device that transmits signals, each of which results from precoding performed for a plurality of resources in at least a part of a plurality of transmission devices such that equivalent channel vectors of undesired signals in a reception device are made to be orthogonal to a reception weight vector used in the reception device, the reception device receiving at least one desired signal and a plurality of undesired signal, the number of which is greater than or equal to the degree of freedom that the plurality of resources have. The at least one desired signal and the plurality of undesired signals have been transmitted. The plurality of resources is the unit of precoding. A channel state information estimation signal is transmitted by using resources that are orthogonal to one another with respect to the plurality of transmission devices in order to estimate the equivalent channel vector of the desired signal and the equivalent channel vectors of the plurality of undesired signals in the reception device. The channel state information estimation signal has been used in the precoding.

The present specification contains the contents of the specification and/or drawings of Japanese Patent Application No. 2011-003047 that was filed in the Japan Patent Office and to which the present application claims priority.

### Advantageous Effects of Invention

According to the present invention, the degradation of the reception characteristics may be suppressed in a system that uses IA even under the circumstances in which a CSI error occurs.

### BRIEF DESCRIPTION OF DRAWINGS

FIG. 1 is a functional block diagram illustrating an exemplary structure of a wireless communication system according to a first embodiment of the present invention.

FIG. 2 is a functional block diagram illustrating an exemplary structure of a transmission device according to the present embodiment.

FIG. 3 is a diagram illustrating pilot signals transmitted at different times from each of transmit antennas of each of transmission devices in turns and is a diagram in which numbers denote transmit antenna units from which pilot signals are transmitted.

FIG. 4 is a diagram illustrating that signals are transmitted at different times, each of the signals being transmitted from a corresponding terminal device, each of the signals being obtained by multiplying a pilot signal, which is a known base signal, and a corresponding transmission weight vector together.

FIG. 5 is a functional block diagram illustrating an exemplary structure of a reception device according to the present embodiment.

FIG. 6 is a functional block diagram of a modified example of the wireless communication system according to the first embodiment of the present invention.

FIG. 7 is a diagram illustrating a state in which H₂′v₂ is divided into a vector p (=aH₃′v₃) and a vector q, the vector p being obtained by projecting H₂′v₂ onto H₃′v₃ and the vector q being orthogonal to the vector p.

### DESCRIPTION OF EMBODIMENTS

In the following, wireless communication technologies according to embodiments of the present invention will be described with reference to the drawings.

### First Embodiment

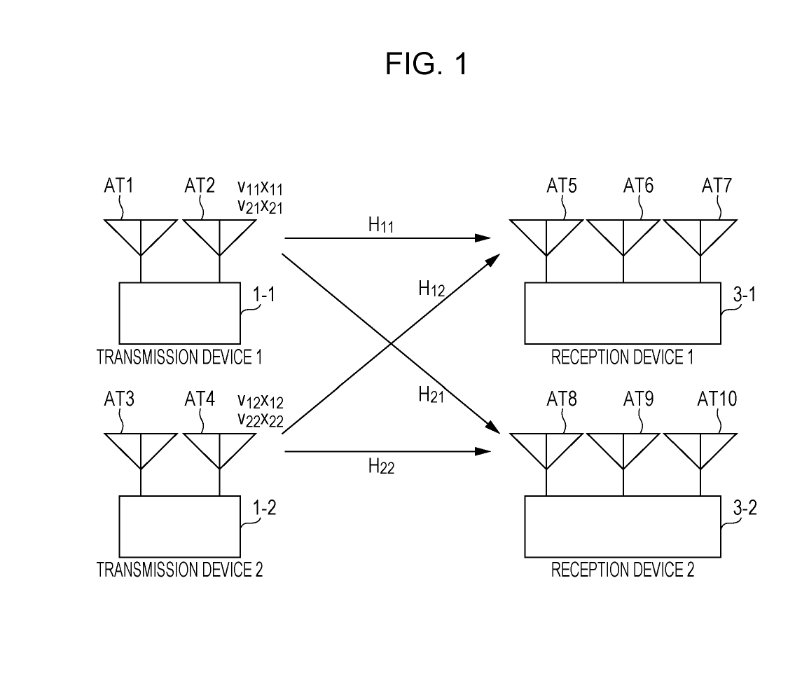

First, in the case where IA is used in a system illustrated in FIG. 1, a first embodiment of the present invention shows reception weight vectors for reducing degradation of reception characteristics under circumstances in which the CSI fed back from a reception device differs from the CSI used at the time when a signal to which IA has been applied is actually transmitted from a transmission device to the reception device, that is, under circumstances in which a CSI error occurs.

As illustrated in FIG. 1, two transmission devices each have two transmit antennas; a transmission device 1-1 has transmit antennas AT1 and 2 and a transmission device 1-2 has transmit antennas AT3 and 4. Two reception devices each have three receive antennas; a reception device 3-1 has receive antennas AT5, 6, and 7, and a reception device 3-2 has receive antennas AT8, 9, and 10. Moreover, xᵢⱼ denotes a signal destined for a reception device i and transmitted from a transmission device j; vᵢⱼ denotes a transmission weight vector (a precoding vector), which and a signal destined for the reception device i and transmitted from the transmission device j are multiplied together; and Hᵢⱼ denotes a channel matrix between the transmission device j and the reception device i (i≠j). In such a case, when IA is applied and it is assumed that there is no CSI error, Hᵢᵢvⱼᵢ=kHᵢⱼvⱼⱼ is satisfied, the IA being IA with which transmission weight vectors of transmission devices are adjusted in a collaboration manner such that equivalent channel vectors of interference signals (undesired signals) are brought into alignment at the time of reception. Thus, a reception signal yᵢ received by the reception device i is expressed as the following Equation (6). Note that k is an arbitrary scalar value and thermal noise components added at the reception device are ignored.

[Math. 6]

yᵢ=Hᵢᵢvᵢᵢxᵢᵢ+Hᵢⱼvᵢⱼxᵢⱼ+Hᵢⱼvᵢⱼ+Hᵢⱼvⱼⱼ(kxⱼᵢ+xⱼⱼ) (6)

In contrast, in the case where there is a CSI error, the reception signal yᵢ is expressed as the following Equation (7). Note that H′ denotes a channel matrix to which the channel matrix obtained at the time of CSI estimation has been changed.

[Math. 7]

yᵢ=H′ᵢᵢvᵢᵢxᵢᵢ+H′ᵢⱼvᵢⱼxᵢⱼ+H′ᵢᵢvⱼᵢxⱼᵢ+H′ᵢⱼvⱼⱼxⱼⱼ (7)

In this way, in the case where there is a CSI error, even when the transmission weight vectors of transmission devices are adjusted in a collaboration manner so as to satisfy HᵢᵢVⱼᵢ=kHᵢⱼvⱼⱼ, the vectors of interference signals are unable to be brought into alignment at the time of reception and circumstances occur in which the degree of freedom is insufficient. In this case, it is impossible to completely eliminate interference. In order to reduce the effects of interference as much as possible, reception weight vectors as described below need to be used.

First, a reception weight vector uᵢᵢ for extracting a desired signal xᵢᵢ is the complex conjugate transpose of a right-singular vector corresponding to the smallest singular value from among right-singular vectors obtained by performing SVD on the following matrix.

[Math. 8]

[H′ᵢⱼvᵢⱼH′ᵢᵢvⱼᵢH′ᵢⱼvⱼⱼ]^{H} (8)

That is, uᵢᵢ is obtained from uᵢᵢ=e₃_{_{—}}ᵢᵢ^{H} by using a vector e₃_{_{—}}ᵢᵢ in Equation (9). Note that Fᵢᵢ and Eᵢᵢ are unitary matrices and Dᵢᵢ is a diagonal matrix with nonnegative real numbers on the diagonal.

[Math. 9]

[H′ᵢⱼvᵢⱼH′ᵢᵢvⱼᵢH′ᵢⱼvⱼⱼ]^{H}=FᵢᵢDᵢᵢEᵢᵢ^{H}=FᵢᵢDᵢᵢ[e₁_{_{—}}ᵢᵢe₂_{_{—}}ᵢᵢe₃_{_{—}}ᵢᵢ]^{H} (9)

The matrix shown on the left-hand side of Equation (9) (or Equation (8)) is the complex conjugate transpose of a matrix in which signals other than a desired signal (here, xᵢᵢ) to be extracted are arranged, that is, in which all the equivalent channel vectors of interference signals are arranged. The vector e₃_{_{—}}ᵢᵢ obtained by performing SVD on this matrix is a vector for receiving the interference signals (xᵢⱼ, xⱼᵢ, xⱼⱼ) with the smallest gain in the equivalent channel obtained after changes in channels have occurred. Thus, it is possible to minimize interference by multiplying a reception signal and this vector together.

Moreover, similarly to uᵢᵢ, a reception weight vector uᵢⱼ for extracting a desired signal xᵢⱼ is the complex conjugate transpose of a right-singular vector corresponding to the smallest singular value from among right-singular vectors obtained by performing SVD on the following matrix.

[Math. 10]

[H′ᵢᵢvᵢᵢH′ᵢᵢvⱼᵢH′ᵢⱼvⱼⱼ]^{H} (10)

That is, uᵢⱼ is obtained from uᵢⱼ=e₃_{_{—}}ᵢⱼ^{H} by using a vector e₃_{_{—}}ᵢⱼ in Equation (11). Note that Fᵢⱼ and Eᵢⱼ are unitary matrices and Dᵢⱼ is a diagonal matrix with nonnegative real numbers on the diagonal.

[Math. 11]

[H′ᵢᵢvᵢᵢH′ᵢᵢvⱼᵢH′ᵢⱼvⱼⱼ]^{H}=FᵢⱼDᵢⱼEᵢⱼ^{H}=FᵢⱼDᵢⱼ[e₁_{_{—}}ᵢⱼe₂_{_{—}}ᵢⱼe₃_{_{—}}ᵢⱼ]^{H} (11)

In the case where the reception weight vectors as described above are used, Equation (7) is changed to the following Equation (12) and it is impossible to completely eliminate interference. Even though an interference signal denoted by z remains, the desired signals xᵢᵢ and xᵢⱼ are extracted while minimizing interference.

[Math. 12]

uᵢᵢyᵢ=uᵢᵢH′ᵢᵢvᵢᵢxᵢᵢ+uᵢᵢH′ᵢⱼvᵢⱼxᵢⱼ+uᵢᵢH′ᵢᵢvⱼᵢxⱼᵢ+uᵢᵢH′ᵢⱼvⱼⱼxⱼⱼ=uᵢᵢH′ᵢᵢvᵢᵢxᵢᵢ+zᵢᵢ

uᵢⱼyᵢ=uᵢⱼH′ᵢᵢvᵢᵢxᵢᵢ+uᵢⱼH′ᵢⱼvᵢⱼxⱼᵢ+uᵢⱼH′ᵢⱼvⱼⱼxⱼⱼ=uᵢⱼH′ᵢⱼvᵢⱼxᵢⱼ+zᵢⱼ (12)

Moreover, when this is expressed as a matrix operation, [uᵢᵢ^{T} uᵢⱼ^{T}]^{T}yᵢ is obtained. In the case where the phases of desired signals obtained in this way are also compensated, each of the reception weight vectors uᵢ and uᵢⱼ a reception signal should be multiplied together, the reception weight vectors uᵢᵢ and uᵢⱼ being used to reduce interference. Then, each of (uᵢᵢHᵢᵢ′vᵢᵢ)^{H} and (uᵢⱼHᵢⱼ′vᵢⱼ)^{H} and a corresponding one of the results should be multiplied together. That is, for each of the desired signals, the phase of the desired signal may be compensated by performing multiplication using the complex conjugate transpose of a vector obtained by multiplying a corresponding reception weight vector and the equivalent channel vector for the desired signal together. Furthermore, the amplitude of the desired signal may also be compensated by dividing a signal obtained as a result of weight multiplication by the square of the norm of the signal.

Moreover, here, as expressed by Equation (9) or Equation (11), the SVD is performed on the complex conjugate transpose of a matrix in which the equivalent channel vectors of interference signals are arranged, and thus the complex conjugate transpose of a right-singular vector corresponding to the smallest singular value is used as a reception weight vector. However, the SVD may be performed on a matrix in which the equivalent channel vectors of interference signals are arranged. In this case, the complex conjugate transpose of a left-singular vector corresponding to the smallest singular value is used as a reception weight vector.

Even in the case where the IA is applied by using the above-described reception weight vectors but the vectors of interference signals are not completely brought into alignment due to the effects of a CSI error and the interference signals, the number of which is greater than the degree of freedom that a reception device has, are received, it is possible to minimize the effects of interference and to extract desired signals from a reception signal. Thus, the degradation of reception characteristics may be reduced in a system in which IA is used even under the circumstances in which a CSI error occurs.

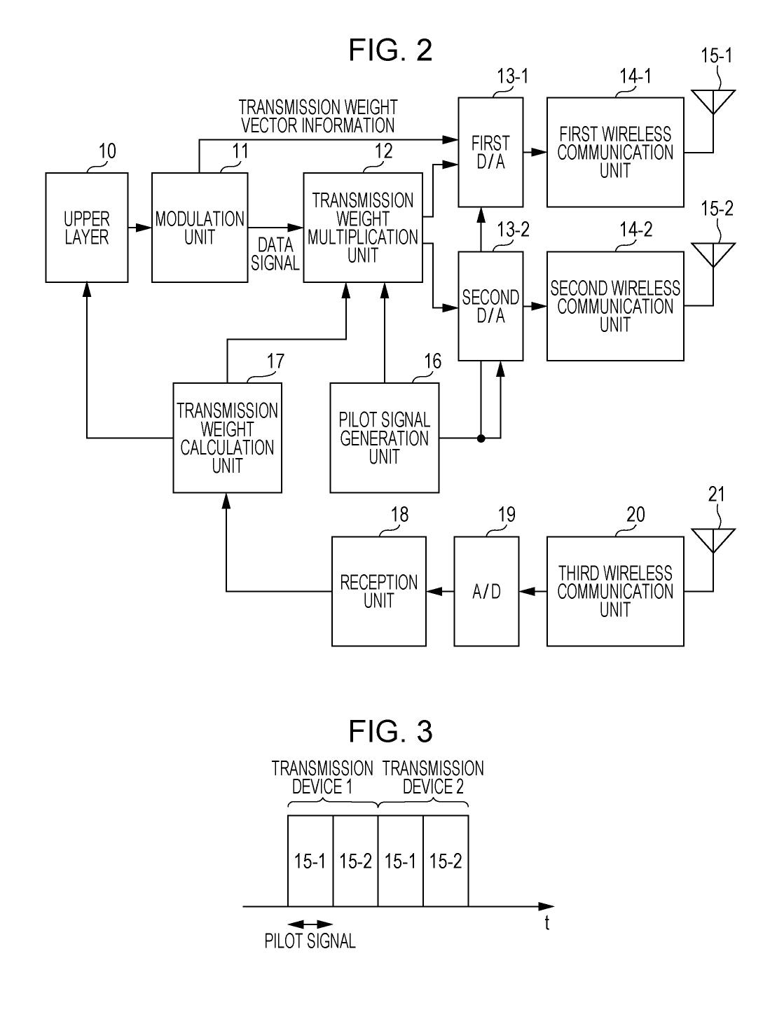

FIG. 2 is a functional block diagram illustrating an exemplary structure of a transmission device according to the present embodiment. Note that the transmission device (1) 1-1 and the transmission device (2) 1-2 illustrated in FIG. 1 have the same structure. As illustrated in FIG. 2, the transmission device in the present embodiment includes an upper layer 10, a modulation unit 11, a transmission weight multiplication unit 12, first and second D/A units 13-1 and 13-2, first and second wireless communication units 14-1 and 14-2, a third wireless communication unit 20, transmit antenna units 15-1 and 15-2, a pilot signal generation unit 16, a transmission weight calculation unit 17, a reception unit 18, an A/D unit 19, and a receive antenna unit 21.

In the transmission device illustrated in FIG. 2, first, a known pilot signal (which may also be referred to as a reference signal) for CSI estimation is transmitted from each of the transmit antennas 15-1 and 15-2 so as to estimate channel matrices (CSI) for a reception device, the channel state information being necessary to perform IA. This pilot signal is generated by the pilot signal generation unit 16 and is input to each of the first and second D/A units 13-1 and 13-2. In the first and second D/A units 13-1 and 13-2, D/A conversion is performed and an input digital signal is converted into an analog signal. A signal resulting from the D/A conversion is input to the first and second wireless communication units 14-1 and 14-2. In the first and second wireless communication units 14-1 and 14-2, frequency conversion is performed on an input baseband signal to obtain a signal whose frequency is in a frequency band over which wireless transmission is possible. The resulting signal is transmitted from each of the transmit antenna units 15-1 and 15-2. Transmission of such a pilot signal is performed before transmission of a data signal and may be transmitted in frames different from frames in which a data signal is transmitted.

Here, it is necessary to make pilot signals, which are to be transmitted from the transmit antennas 15-1 and 15-2, be orthogonal to one another (or prevent from interfering with one another) in order to make a reception device estimate channels between the reception device and each of the transmit antennas 15-1 and 15-2 of each transmission device. Methods for making pilot signals be orthogonal to one another include a method in which pilot signals are made to be orthogonal to one another in the time domain, a method in which pilot signals are made to be orthogonal to one another in the frequency domain, a method in which pilot signals are made to be orthogonal to one another by using orthogonal codes, and the like. Any of the methods may be applied to the present invention. Here, FIG. 3 illustrates an example of the case where pilot signals are made to be orthogonal to one another in the time domain. FIG. 3 illustrates pilot signals transmitted at different times from each of the transmit antennas of each of the transmission devices in turns. The numbers illustrated in FIG. 3 correspond to the numbers of the transmit antenna units from which a pilot signal is transmitted. In transmission devices according to the present embodiment, as illustrated in FIG. 3, pilot signals are made to be orthogonal to one another in the time domain and transmitted, and consequently, this makes it possible for a reception device to estimate a channel. Note that the order in which pilot signals illustrated in FIG. 3 are transmitted is an example, and the order in which pilot signals are transmitted is not limited this.

In addition, as described above, pilot signals may also be made to be orthogonal to one another in the frequency domain. In this case, it is desirable that each transmit antenna be configured to transmit a pilot signal in a corresponding one of sub-carriers in multicarrier transmission. This may be realized as follows. For example, there are four sub-carriers. In this case, in a sub-carrier 1, a pilot signal is transmitted from the transmit antenna unit 15-1 of the transmission device 1. In a sub-carrier 2, a pilot signal is transmitted from the transmit antenna unit 15-2 of the transmission device 1. In a sub-carrier 3, a pilot signal is transmitted from the transmit antenna unit 15-1 of the transmission device 2. In a sub-carrier 4, a pilot signal is transmitted from the transmit antenna unit 15-2 of the transmission device 2.

Furthermore, in the case where pilot signals are made to be orthogonal to one another by using orthogonal codes, the pilot signals to be transmitted from the transmit antennas and orthogonal codes are multiplied together, the orthogonal codes being different from each other and a pilot signal to be transmitted from each of the transmit antennas and a corresponding one of the orthogonal codes being multiplied together. A reception device is configured to separate the received pilot signal into pilot signals transmitted from the transmit antennas by multiplying the received pilot signal and, again, these orthogonal codes together and to estimate each channel matrix.

In this way, transmission device transmit pilot signals that are orthogonal to one another and a reception device estimates channel matrices in accordance with the pilot signals. The estimated channel matrices are fed back as CSI from the reception device to the transmission devices. Here, the CSI, which is fed back, is each of the channel matrices H expressed in Equation (6) described above. In the present embodiment, all the channel matrices are fed back to each transmission device. The CSI fed back from the reception device is received by the receive antenna unit 21 of the transmission device illustrated in FIG. 2 and input to the third wireless communication unit 20. In the third wireless communication unit 20, frequency conversion from the wireless frequency band to the baseband is performed. The signal on which the frequency conversion has been performed is input to the A/D unit 19. In the A/D unit 19, A/D conversion is performed on the signal, an analog signal being converted into a digital signal in A/D conversion. The signal resulting from the A/D conversion is input to the reception unit 18. In the reception unit 18, the CSI fed back from the reception device is recovered and each of the channel matrices H is understood by the transmission device.

The channel matrices recovered by the reception unit 18 are input to the transmission weight calculation unit 17 and used to calculate a transmission weight vector. Here, in the case where IA is performed with respect to a plurality of transmission devices, it is necessary to adjust transmission weight vectors, which are to be used, for the transmission devices in a collaboration manner such that the directions of interference vectors are brought into alignment in the reception device. However, the present invention does not specify a method for calculating these transmission weight vectors, and any method may be used. For example, a method may be used in which v₁₁ is determined by the transmission device (1) 1-1 and v₂₂ is determined by the transmission device (2) 1-2, the transmission devices (1) 1-1 and (2) 1-2 exchange information regarding the determined transmission weight vectors, v₂₁ is calculated from v₂₁=kH₁₁⁺H₁₂v₂₂ in the transmission device (1) 1-1, and v₁₂ is calculated from v₁₂=kH₂₂⁺H₂₁v₁₁ in the transmission device (2) 1-2. Note that k is an arbitrary scalar and ⁺ represents a generalized inverse.

Here, v₁₁ and v₂₂ determined first may be arbitrary vectors; however, it is desirable that they be unitary vectors, considering limited transmission power. Alternatively, a determination method may be used in which v₁₁ is set to a right-singular vector that is obtained by performing SVD on H₁₁ and that corresponds to the largest singular value and v₂₂ is set to a right-singular vector that is obtained by performing SVD on H₂₂ and that corresponds to the largest singular value.

Alternatively, a determination method may be used in which two transmission weight vectors v₁₁ and v₂₁ are first determined by the transmission device (1) 1-1, the transmission device (2) 1-2 is notified of the information regarding the determined transmission weight vectors, v₁₂ and v₂₂ are determined in the transmission device (2) 1-2 by using the relationships v₁₂=kH₂₂⁺H₂₁v₁₁ and v₂₂=kH₁₂⁺H₁₁v₂₁ in accordance with the notified information. In this case, v₁₁ and v₂₁ that have been first determined may be arbitrary vectors that satisfy the relationship v₁₁≠av₂₁ (a is an arbitrary scalar); however, it is desirable that the vectors be orthogonal to one another in order to efficiently eliminate interference in the reception device. Alternatively, a determination method may be used in which v₁₁ is set to a right-singular vector that is obtained by performing SVD on H₁₁ and that corresponds to the largest singular value and v₂₁ is set to a right-singular vector that is obtained by performing SVD on H₂₁ and that corresponds to the largest singular value. Here, an example in which two transmission weight vectors are first determined in the transmission device (1) 1-1 has been described; however, in contrast, transmission weight vectors may be first determined in the transmission device (2) 1-2 and the transmission device (1) 1-1 may be notified of the information regarding the determined transmission weight vectors.

The calculation method in which transmission weight vectors are calculated in a collaboration manner is a mere example, and the present invention does not specify a calculation method for calculating transmission weight vectors but calculation of such transmission weight vectors is performed by the transmission weight calculation unit 17. Note that, as described above, the transmission weight vectors in the present embodiment include a transmission weight vector determined first and a transmission weight vector determined in accordance with the transmission weight vector determined first. The structure in which another transmission device is notified of a transmission weight vector determined first and the structure in which information regarding a transmission weight vector that is notified by the other transmission device is received are necessary. Thus, a transmission weight vector determined first by the transmission weight calculation unit 17 is input to the upper layer 10 and then modulated by the modulation unit 11 in a modulation method such as QPSK (Quadrature Phase Shift Keying), 16QAM (Quadrature Amplitude Modulation), or the like. D/A conversion is performed by the first D/A unit 13-1, and then the resulting signal flows via the first wireless communication unit 14-1 and is transmitted from the antenna unit 15-1. In the case where it is necessary to notify another transmission device of information regarding the determined transmission weight vector, notification is performed in this way. Note that, the present embodiment shows an example in which another transmission device is notified of a transmission weight vector only from one antenna. Moreover, similarly to the CSI fed back from a reception device, the information regarding a transmission weight vector that has been notified from the other transmission device is received by the receive antenna unit 21 and input to the transmission weight calculation unit 17 via the wireless communication unit 20, the A/D unit 19, and the reception unit 18. Here, an example is shown in which the information regarding a transmission weight vector is transmitted to or received from in a wireless manner; however, in the case where transmission devices are connected with each other in a wired manner similarly to base stations in a cellular system, transmission devices may be configured to perform notification of a transmission weight vector via a wired network.

With the above-described structure, transmission weight vectors may be calculated. Next, transmission of data signals by using calculated transmission weight vectors will be described. First, the transmission weight vectors calculated by the transmission weight calculation unit 17 (v₁₁ and v₂₁ in the transmission device (1) 1-1 and v₁₂ and v₂₂ in the transmission device (2) 1-2) are input to the transmission weight multiplication unit 12. A data signal, which has been input to the modulation unit 11 from the upper layer 10 and has been modulated, is input to the transmission weight multiplication unit 12 in addition to the above-described transmission weight vectors, and the data signal and a transmission weight vector are multiplied together in the transmission weight multiplication unit 12.

Moreover, a known pilot signal is input from the pilot signal generation unit 16 to the transmission weight multiplication unit 12. Similarly to a data signal, the known pilot signal and a transmission weight vector are multiplied together. This pilot signal is a signal that is necessary to calculate reception weight vectors, which are used in the reception device. In order to calculate the reception weight vectors, it is necessary to estimate equivalent channel vectors such as those expressed in Equation (8) or Equation (10). Thus, the pilot signal and the transmission weight vector, which is the same as that used for the data signal, are multiplied together and transmitted.

In this way, signals obtained by multiplying each of a pilot signal and a data signal and a transmission weight vector together in the transmission weight multiplication unit 12 are input to the first and second D/A units 13-1 and 13-2, and D/A conversion is performed. Thereafter, in the first and second wireless communication units 14-1 and 14-2, frequency conversion to the wireless frequency band is performed. Each of the resulting signals is transmitted from a corresponding one of the transmit antenna units 15-1 and 15-2. Here, the signal obtained by multiplying the pilot signal and the transmission weight vector together is used to calculate reception weight vectors, that is, to demodulate the data signal; thus, the signal is multiplexed in the same frame as the data signal.

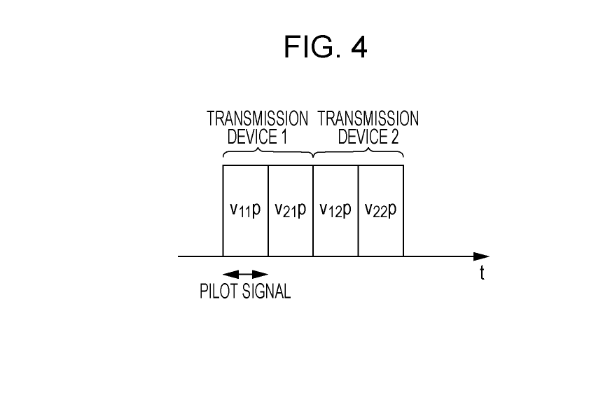

Note that, in order to estimate equivalent channel vectors as expressed in Equation (8) or Equation (10), similarly to the pilot signals for CSI estimation, pilot signals need to be orthogonal to one another and transmitted such that the pilot signals are not interfering with one another. For example, in the case where pilot signals are made to be orthogonal to one another in the time domain, pilot signals are transmitted as illustrated in FIG. 4. FIG. 4 illustrates the case where signals are transmitted at different times, each of the signals being transmitted from a corresponding terminal device, each of the signals being obtained by multiplying a known pilot signal p and a transmission weight vector v together, the known pilot signal p being a base signal. FIG. 4 is a diagram that is almost similar to FIG. 3, which illustrates the pilot signals for CSI estimation. The pilot signals for CSI estimation are made to be orthogonal to one another on a transmit-antenna-by-transmit-antenna basis and transmitted. In contrast, a pilot signal for reception-weight-vector calculation is transmitted from two transmit antennas of a transmission device. This is a difference between the pilot signals for CSI estimation and pilot signals for reception-weight-vector calculation. This indicates that, for example, v₁₁p is a vector with two rows and one column, the element at the first row and first column is transmitted from the transmit antenna unit 15-1 of the transmission device (1) 1-1, and the element at the second row and first column is transmitted from the transmit antenna unit 15-2 of the transmission device (1) 1-1.

Here, the case where pilot signals are made to be orthogonal in the time domain has been described; however, pilot signals may be made to be orthogonal not in the time domain but in the frequency domain. Alternatively, pilot signals may be made to be orthogonal by multiplying each pilot signal and a corresponding one of a plurality of different orthogonal codes together. A system in which IA is used and that does not cause a CSI error is a target system in the present invention. In such a system, since the directions of received interference vectors are brought into alignment, when equivalent channel vectors as expressed in Equation (3) may be estimated, reception weight vectors may be calculated. Thus, it is not necessary to estimate equivalent channel vectors of interference signals coming from all the interference sources. However, in the case where a CSI error occurs, in order to estimate all the equivalent channel vectors of interference signals coming from all the interference source as expressed in Equation (8) or Equation (10), it is necessary to make all signals be orthogonal to one another and transmit the resulting signals, the all signals being obtained by multiplying, together, each of the pilot signals and a corresponding transmission weight vector the same as that used for a data signal.

Since the transmission devices have a structure as described above, transmission using IA is possible. Moreover, in the case where a CSI error occurs, the equivalent channel vectors of interference signals may be estimated, the equivalent channel vectors of interference being necessary when the reception device calculates reception weight vectors with which degradation of characteristics due to the effects of the CSI error is minimized.

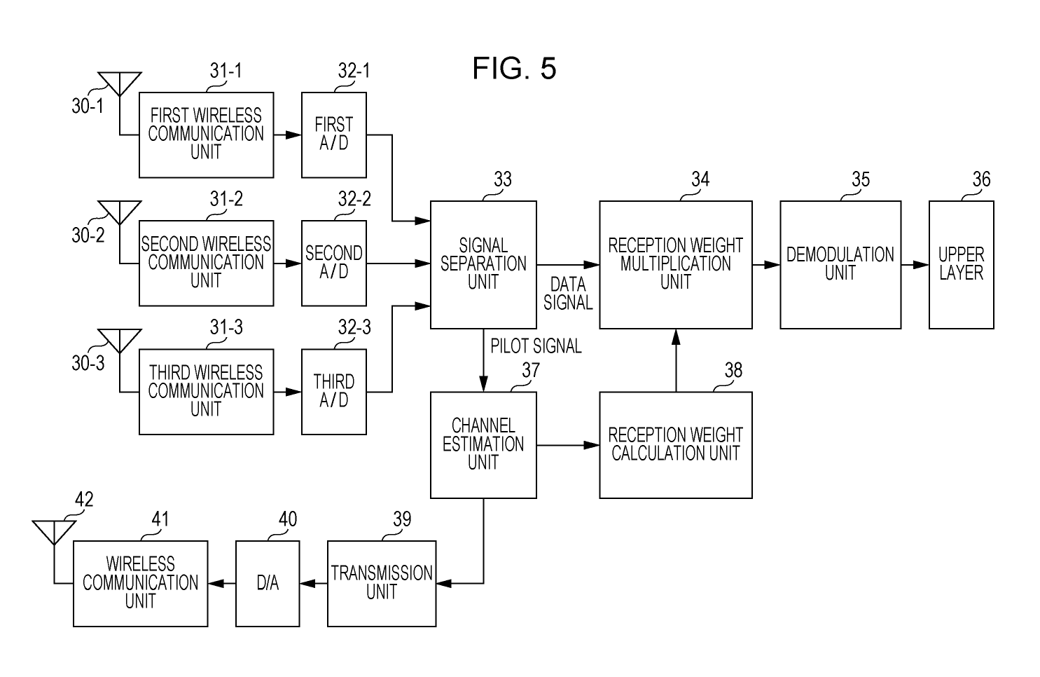

Next, FIG. 5 illustrates a functional block diagram of an exemplary structure of the reception device according to the present embodiment. Note that reception devices (1) 3-1 and (2) 3-2 have the same structure. As illustrated in FIG. 5, the reception device according to the present embodiment includes receive antenna units 30-1, 30-2, and 30-3, first to third wireless communication units 31-1, 31-2, and 31-3, a wireless communication unit 41, first to third A/D units 32-1, 32-2, and 32-3, a signal separation unit 33, a reception weight multiplication unit 34, a demodulation unit 35, an upper layer 36, a channel estimation unit 37, a reception weight calculation unit 38, a transmission unit 39, a D/A unit 40, and a transmit antenna unit 42.

In the reception device illustrated in FIG. 5, signals transmitted from a transmission device are received by each receive antenna included in the receive antenna units 30-1 to 30-3 and are input to the wireless communication units 31-1 to 31-3. In the wireless communication units 31-1 to 31-3, frequency conversion from the wireless frequency band to the baseband is performed on the received signals. Next, the received signals are converted from analog signals to digital signals in the A/D units 32-1 to 32-3. The received signals, which have been converted into digital signals, are input to the signal separation unit 33 and are separated into pilot signals and a data signal. The data signal is input to the reception weight multiplication unit 34 and the pilot signals are input to the channel estimation unit 37. Note that, as described above, the pilot signals for CSI estimation may be individually transmitted in frames different from frames for the data signal. In such a case the signal separation unit 33 does not perform signal separation and simply inputs the received pilot signals, which are input pilot signals, to the channel estimation unit 37.

In the channel estimation unit 37 to which the received pilot signals have been input, channel estimation is performed by using known pilot signals. When the channel estimation is performed by using the pilot signals for CSI estimation (see FIG. 3), processing is performed in which channel matrices H between each of the transmit antennas of each transmission device and each of the receive antennas of the reception device are estimated. When the channel estimation is performed by using the pilot signals for reception-weight-vector calculation (see FIG. 4), processing is performed in which equivalent channel vectors Hv as expressed in Equation (8) or Equation (10) are estimated. Such estimation is performed by the channel estimation unit 37. The channel matrices estimated by using the pilot signals for CSI estimation and the equivalent channel vectors estimated by using the pilot signals for reception-weight-vector calculation are input to the transmission unit 39 and to the reception weight calculation unit 38, respectively.

In the transmission unit 39, to which the channel matrices estimated by using the pilot signals for CSI estimation have been input, the channel matrices are converted into a format in which the channel matrices may be transmitted. The converted channel matrices, which are digital signals, are converted into analog signals by the D/A unit 40. Thereafter, the analog signals flow via the wireless communication unit 41 and are transmitted from the transmit antenna unit 42 to transmission devices. By performing such processing, the channel matrices between each of the transmit antennas of the transmission devices and the receive antennas are estimated and the estimation results may be fed back as CSI to the transmission devices.

Moreover, equivalent channel vectors necessary for reception-weight-vector calculation according to the present embodiment are first extracted in the reception weight calculation unit 38, to which the equivalent channel vectors estimated by using the pilot signals for reception-weight-vector calculation have been input. A matrix such as a matrix expressed as Equation (8) or Equation (10) is constituted by using the extracted equivalent channel vectors. Then, reception weight vectors u (u₁₁ and u₁₂ in the reception device (1) 3-1 and u₂₁ and u₂₂ in the reception device (2) 3-2) are calculated by performing calculation (SVD) expressed as Equation (9) or Equation (11), the reception weight vectors being used to minimize the effects of interference occurring due to the effects of a CSI error. As described above, the reception weight vectors u may be calculated so as to compensate the phases and amplitudes of desired signals.

The reception weight vectors u calculated by the reception weight calculation unit 38 in this way are input to the reception weight multiplication unit 34, and the data signal input from the signal separation unit 33 and the reception weight vectors u are multiplied together. As a result of this multiplication, signals as expressed in Equation (12) or signals expressed in Equation (12) including the desired-signal components, the phases and amplitudes of which have been also compensated, are obtained and these signals are demodulated by the demodulation unit 35 and input to the upper layer 36.

Since the reception device has such a structure, in the case where a CSI error occurs in a system using IA, the equivalent channel vectors of interference signals coming from all the interference sources may be estimated and the reception weight vectors for minimizing degradation of characteristics due to the effects of a CSI error may be calculated. Moreover, the channel matrices for the transmit antennas of each transmission device are estimated and may be fed back as CSI.

The desired signals are extracted by multiplying the received data signal and the reception weight vectors together as described above. Thus, even in the case where a CSI error occurs in a system using IA, the degradation of characteristics due to the effects of a CSI error may be reduced. In addition to this, there is a method for calculating reception weight vectors for reducing degradation of characteristics. For example, in the case where a reception device may know vectors (equivalent channel vectors) of interference signals that are supposed to be brought into alignment when a CSI error has not occurred, reception weight vectors may be calculated using the equivalent channel vectors of interference signals that are supposed to be brought into alignment. Specifically, instead of performing, for example, Equation (8), the complex conjugate transpose of a right-singular vector corresponding to the smallest singular value (zero) from among right-singular vectors obtained by performing SVD on [Hᵢⱼ′vᵢⱼ Hᵢᵢvⱼᵢ]^{H} may be used as a reception weight vector. Here, H′v represents an equivalent channel vector in the case where a CSI error occurs and Hv represents an equivalent channel vector in the case where no CSI occurs.

Moreover, a vector at the midpoint of equivalent channel vectors of interference signals that are not brought into alignment due to a CSI error may be calculated, and a reception weight vector may be calculated using the vector at the midpoint. Specifically, for example, instead of performing Equation (8), the complex conjugate transpose of a right-singular vector corresponding to the smallest singular value (zero in this case) from among right-singular vectors obtained by performing SVD on [Hᵢⱼ′vᵢⱼ (Hᵢᵢ′v_{ji+H}ᵢⱼ′vⱼⱼ)/2]^{H} is used as a reception weight vector. Note that, here, both vectors (Hᵢᵢ′vⱼᵢ and Hᵢⱼ′vⱼⱼ) used to calculate the vector at the midpoint are equivalent channel vectors for signals that are not desired signals. Although Hᵢⱼ′vᵢⱼ is treated as interference when xᵢᵢ is extracted, Hᵢⱼ′vᵢⱼ is actually an equivalent channel vector of xᵢⱼ, that is, a desired signal. Thus, Hᵢⱼ′vᵢⱼ is not used to calculate a vector at the midpoint. In this way, a method in which a vector at the midpoint of the equivalent channel vectors of interference signals is used to calculate a reception weight vector is significantly effective as a method for reducing degradation of characteristics due to the effects of a CSI error, in the case where a leading cause that makes a CSI error occur is noise added to pilot signals in a reception device.

Furthermore, a reception weight vector may be calculated using an equivalent channel vector whose norm (size) is the largest from among the equivalent channel vectors of interference signals that are not brought into alignment due to a CSI error. Specifically, for example, in the case of |Hᵢᵢ′vⱼᵢ|²>|Hᵢⱼ′vⱼⱼ|², instead of performing Equation (8), the complex conjugate transpose of a right-singular vector corresponding to the smallest singular value (zero in this case) from among right-singular vectors obtained by performing SVD on [Hᵢⱼ′vᵢⱼ Hᵢᵢ′vⱼᵢ]^{H} is used as a reception weight vector. A larger interference component may be completely eliminated by using such a reception weight vector and thus the degradation of characteristics due to a CSI error may be reduced.

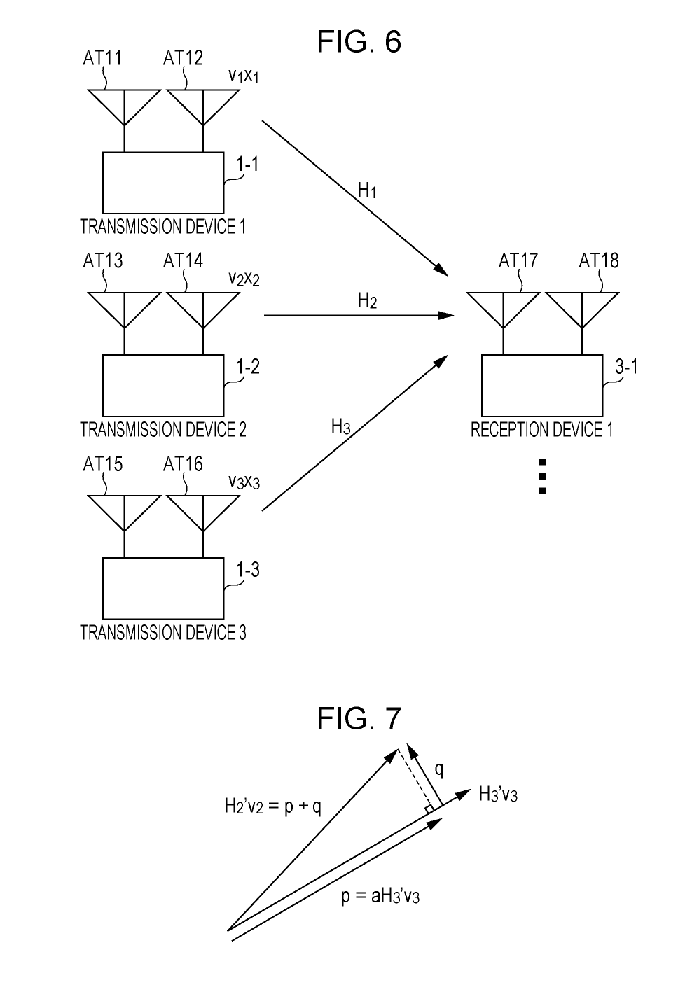

Moreover, calculation of reception weight vectors according to the present embodiment may be applied not only to the system having a structure illustrated in FIG. 1 but also to a system as illustrated in FIG. 6. Here, FIG. 6 illustrates a part of a system in which transmission devices each having two transmit antennas perform transmission on a stream-by-stream basis (a stream being also called a rank) to reception devices each having two receive antennas. FIG. 6 illustrates a system in which the transmission device (1) 1-1 transmits a signal x₁ to the reception device (1) 3-1, the transmission device (2) 1-2 transmits a signal x₂ to a reception device 2, which is not illustrated, and a transmission device (3) 1-3 transmits a signal x₃ to a reception device 3, which is not illustrated. Here, H₂v₂x₂ and H₃v₃x₃ are interference signals for the reception device (1) 3-1. Thus, IA is applied such that these vectors of interference signals are brought into alignment when the interference signals are received by the reception device (1) 3-1. That is, the transmission weight vectors are adjusted in the transmission device (2) 1-2 and the transmission device (3) 1-3 and transmitted such that H₂v₂=kH₃v₃ (k is an arbitrary scalar) is satisfied. In such a system, in the case where a channel matrix H is changed to a channel matrix H′, H₂′v₂≠kH₃′v₃ is obtained and the vectors of interference signals are not brought into alignment. As a result, the reception characteristics are significantly degraded due to the effects of interference signals, the number of which exceeds the degree of freedom. However, even in such a case, as described above, the effects of interference may be minimized by using, as a reception weight vector, the complex conjugate transpose of a right-singular vector corresponding to the smallest singular value from among right-singular vectors obtained by performing SVD on a complex conjugate transposed matrix [H₂′v₂ H₃′v₃]^{H}, which is the complex conjugate transpose of a matrix in which equivalent channel vectors of interference signals are arranged.

Furthermore, in the case where another transmission device is added and a transmission device 4 transmits a signal x₄ by using a transmission weight vector v₄ to a reception device 4, when a CSI error occurs, three interference signals H₂′v₂x₂, H₃′v₃x₃, and H₄′v₄x₄ arrive at the reception device 1. Even in such a case, the effects of interference may be reduced by calculating a reception weight vector by using a similar method. Specifically, it is desirable that the complex conjugate transpose of a right-singular vector corresponding to the smallest singular value from among right-singular vectors obtained by performing SVD on [H₂′v₂ H₃′v₃ H₄′v₄]^{H} be used as a reception weight vector. Moreover, in the case where the SVD is performed on [H₂′v₂ H₃′v₃ H₄′v₄], the complex conjugate transpose of a left-singular vector corresponding to the smallest singular value may be used as a reception weight vector.

In this way, in the case where the number of interference sources is increased, the effects of interference may be reduced by using reception weight vectors calculated in accordance with equivalent channel vectors of interference signals, the equivalent channel vectors being obtained after changes in channels have occurred.

### Second Embodiment

Next, a second embodiment of the present invention will be described with reference to the drawings.

In the first embodiment, the reception weight vectors for minimizing interference occurring due to a CSI error under circumstances in which a CSI error occurs in a system in which IA is used, have been described as an example. The reception characteristics of a reception device depend not only on interference but also on thermal noise within the reception device. Thus, in contrast to the case where reception weight vectors obtained by considering only interference are used, the characteristics may be improved by using reception weight vectors obtained by considering both interference and thermal noise. In the present embodiment, a reception weight vector obtained by considering not only interference occurring due to a CSI error but also thermal noise within a reception device will be described. Specifically, the system illustrated in FIG. 6 is used as an example and a reception weight vector is calculated in accordance with MMSE (Minimum Mean Square Error) standards with which the mean square error between a reception signal and a desired signal is minimized.

As described above, FIG. 6 illustrates the part of the system in which transmission devices each having two transmit antennas perform transmission on a stream-by-stream basis to reception devices each having two receive antennas. FIG. 6 illustrates a system in which the transmission device (1) 1-1 transmits a signal x₁, on which precoding has been performed by using a transmission weight vector v₁, to the reception device 3; the transmission device (2) 1-2 transmits a signal x₂, on which precoding has been performed by using a transmission weight vector v₂, to the reception device 2, which is not illustrated; and the transmission device (3) 1-3 transmits a signal x₃, on which precoding has been performed by using a transmission weight vector v₃, to the reception device 3, which is not illustrated. Here, H₂v₂x₂ and H₃v₃x₃ are interference signals for the reception device 1. Thus, IA is applied such that these vectors of interference signals are brought into alignment when the interference signals are received by the reception device 1.

In such a system, in the case where no CSI error occurs, a reception signal y₁ in the reception device 1 is expressed as the following equation. Note that H₂v₂=kH₃v₃ is satisfied by IA and n₁ represents Gaussian noise that is added to a reception signal in a reception device and whose variance is denoted by σ².

[Math. 13]

y₁=H₁v₁x₁+H₂v₂x₂+H₃v₃x₃+n₁=H₁v₁x₁+H₃v₃(kx₂+x₃)+n₁ (18)

In contrast, in the case where a channel matrix H is changed to H′ and a CSI error occurs, H₂′v₂≠kH₃′v₃ is satisfied and the reception signal y₁ is expressed as the following equation.

[Math. 14]

y₁=H′₁v₁x₁+H′₂v₂x₂+H′₃v₃x₃+n₁ (14)

Here, x₁ is a desired signal for the reception device 1. Thus, the reception signal y₁ expressed as Equation (14) is the sum of the desired signal, two interference signals H₂′v₂x₂ and H₃′v₃x₃, and the thermal noise n₁. A reception weight vector u for minimizing the mean square error between the reception signal y₁ and the desired signal x₁ may be obtained by solving the following equation.

$$\begin{matrix}[ Math . 15 ] & \\ {argmin}_{u} E ( {‖ ɛ ‖}_{2}^{2} ) \\ ɛ = u {y}_{1} - {x}_{1} = u ( {H}_{1}^{′} {v}_{1} {x}_{1} + {H}_{2}^{′} {v}_{2} {x}_{2} + {H}_{3}^{′} {v}_{3} {x}_{3} + {n}_{1} ) - {x}_{1} & ( 15 )\end{matrix}$$

Note that the first equation of Equation (15) indicates that a reception weight vector u is obtained with which the mean square norm (E(c) represents the average of c) of an error ε is minimized, the error ε is obtained between a result obtained by multiplying a reception signal and the reception weight vector u together and the desired signal. Here, assuming that power of each of the transmission signals x₁, x₂, and x₃ is one, the reception weight vector u satisfying Equation (15) is expressed as the following equation.

[Math. 16]

u=(H′₁v₁)^{H}{(H′₁v₁)(H′₁v₁)^{H}+(H′₂v₂)(H′₂v₂)^{H}+(H′₃v₃)(H′₃v₃)^{H}+σ²I}⁻¹ (16)

In this way, in a system in which IA is used, a reception weight vector for minimizing the mean square error about a desired signal may be calculated in accordance with each of the equivalent channel vectors of the desired signal and interference signals. The degradation of characteristics due to the effects of a CSI error may be reduced by multiplying a reception signal and this reception weight vector together. Note that, here, it is assumed that the power of each of the transmission signals x₁, x₂, and x₃ is one, and consequently, σ² and a unit matrix are multiplied together in Equation (16). However, in general, the inverse of SNR and a unit matrix are multiplied together.

The reception weight vector expressed as Equation (16) is a general MMSE reception weight vector in the case where one desired signal and two interference signals arrive. As illustrated in FIG. 6, in the present embodiment, target circumstances are those in which three signals of almost the same power (one desired signal and two interference signals) arrive at a reception device having two receive antennas and the degree of freedom for extracting the desired signal by eliminating the interference signals is insufficient. Thus, in a normal system, it is difficult to appropriately extract a desired signal even when the reception weight vector expressed as Equation (16) is used. For example, equivalent channel vectors of interference signals in Equation (16) are expressed as two vectors H₂′v₂ and H₃′v₃; however, these two vectors are completely independent from each other (the correlation between them is small) in a normal system in which IA is not applied, and are not controlled so as to be easily eliminated on the reception side. Thus, the degree of freedom is insufficient and it is impossible to separate the desired signal from the interference signals even when Equation (16) is used.

However, in the IA used in the present invention, transmission weight vectors used in transmission devices are controlled such that the equivalent channel vectors of interference signals are brought into alignment at the time of reception, that is, such that the interference signals are easily eliminated on the reception side (here, such that H₂v₂=kH₃v₃ is satisfied). Thus, under circumstances in which a CSI error is not so large, the correlation between H₂′v₂ and H₃′v₃ is significantly high. This may be considered to be under circumstances in which H₂′v₂≅kH₃′v₃ is satisfied although the vectors are not completely brought into alignment. Under such circumstances, even in the case where the number of incoming signals is greater than then number of receive antennas, it is considered that the degree of freedom is not completely insufficient. Thus, it is possible to separate the desired signal from the interference signals by using the reception weight vector expressed as Equation (16) and to extract the desired signal. Thus, in the case where interference signals are not completely eliminated due to a CSI error even though the interference signals are controlled so as to be easily eliminated on the reception side, a desired signal may be extracted by using a MMSE reception weight vector as expressed by Equation (16) and a special effect is obtained, which is not obtained in a normal system.

A reception device that uses such a reception weight vector may be realized by using the same structure as the reception device illustrated in FIG. 5. Note that, since the number of receive antennas that the reception device 1 according to the present invention has is two, the receive antenna unit 30-3 to the A/D unit 32-3 in FIG. 5 are unnecessary. Moreover, in the reception device according to the present embodiment, the reception weight vector expressed as Equation (16) is calculated by the reception weight calculation unit 38.

The transmission devices according to the present embodiment may also be realized by using the same structure as the transmission device illustrated in FIG. 2. Note that, since all of the transmission devices (three transmission devices illustrated in FIG. 6) according to the present embodiment each performs transmission on a stream-by-stream basis, the size of a data signal that is input from the upper layer 10 to the modulation unit 11 and modulated by the modulation unit 11 and for which multiplication is performed by the transmission weight multiplication unit is one stream, the data signal and a transmission weight vector being multiplied together in the multiplication. Moreover, in the present embodiment, transmission weight vectors for the transmission device (2) 1-2 and the transmission device (3) 1-3 illustrated in FIG. 6 are adjusted such that H₂v₃=kH₃v₃ is satisfied. As described in the first embodiment, in the present invention, methods for calculating and adjusting the transmission weight vectors are not specified and any method may be used. For example, a method may be used in which, after v₃ has been determined in the transmission device (3) 1-3, the transmission device (2) 1-2 is notified of information regarding the determined transmission weight vector, and v₂ is calculated from v₂=kH₂⁻¹H₃v₃ in the transmission device (2) 1-2. Here, v₃, which has been determined first, may be an arbitrary vector. Moreover, v₁ in the present embodiment may be an arbitrary vector since it is unnecessary to bring the direction of the vector v₁ into alignment with the directions of other signals. A right-singular vector corresponding to the largest singular value obtained as a result of performing SVD on H₁ may also be used.

Moreover, pilot signals may have the same structure as the pilot signals illustrated in FIG. 3 or 4. Furthermore, orthogonalization may be performed not only in the time domain as illustrated in FIG. 3 or 4 but also in the frequency domain such that each transmit antenna transmits a pilot signal in a corresponding one of different sub-carriers in a multicarrier transmission system. Alternatively, orthogonalization may be performed by using different orthogonal codes.

Moreover, in the system illustrated in FIG. 6, the desired signal for the reception device 1 is only x₁; however, a MMSE reception weight vector may be calculated by regarding either x₂ or x₃ as another desired signal. This indicates that the reception weight vector is determined to be the first row vector of H_{eq}^{H}{H_{eq}H_{eq}^{H}+(H₃′v₃)(H₃′v₃)^{H}+σ²I}⁻¹, for example, in the case where x₂ is regarded as another desired signal and the equivalent channel matrix is H_{eq}=[H₁′v₁ H₂′v₂]. Note that any of x₂ and x₃ may be regarded as another desired signal and the first row vector of the equation is the same as the calculation result of Equation (16).

In this way, in the case where a part of the interference signals is regarded as a desired signal and a reception weight vector is calculated, a vector regarded as a desired signal and a vector regarded as an interference signal may be obtained as follows. This is a method in which since the correlation between equivalent channel vectors H₂′v₂ and H₃′v₃ of two interference signals to which IA is applied is significantly high, either one of the vectors is divided into a vector projected onto the other vector and a vector orthogonal to the vector, and the projected vector and the other vector are regarded as an equivalent channel vector of a desired signal and a vector orthogonal to the other vector is regarded as an equivalent channel vector of an interference signal. This method will be described with reference to FIG. 7.

FIG. 7 illustrates a state in which H₂′v₂ is divided into a vector p (=aH₃′v₃) and a vector q, the vector p being obtained by projecting H₂′v₂ onto H₃′v₃ and the vector q being orthogonal to the vector p. Note that a is an arbitrary scalar. Moreover, H₂′v₂ and H₃′v₃ are complex vectors, and thus it is actually impossible to represent them as vectors on a two-dimensional surface. For convenience of explanation, H₂′v₂ and H₃′v₃ are here represented on a two-dimensional surface. In the case where a vector is decomposed in this way, p and H₃′v₃ are vectors whose directions are in alignment, and the sum vector p+H₃′v₃ may be regarded as an equivalent channel vector of one signal. Thus, a reception weight vector may also be calculated by using p+H₃′v₃ as an equivalent channel vector of a desired signal and q as an equivalent channel vector of an interference signal. In this case, the equivalent channel matrix is H_{eq}=[H₁′v₁p+H₃′v₃] and the reception weight vector is determined to be the first row vector of H_{eq}^{H}{H_{eq}H_{eq}^{H}+qq^{H}+σ²I}⁻¹.

Moreover, the equivalent channel matrix may be H_{eq}=[H₁′v₁ H₃′v₃] and, about the vector p, power conversion of a signal may also be taken into consideration. This indicates that the power of a signal received via an equivalent channel having H₃′v₃ is treated as 1+a² since p=aH₃′v₃. The reception weight vector in this case is determined to be the first row vector of H_{eq}^{H}{H_{eq}ΣH_{eq}^{H}+qq^{H}+σ²I}⁻¹. Note that Σ is a diagonal matrix whose diagonal elements are [11+a²].

As described above, the reception weight vector is calculated by regarding a part of the interference signals as a desired signal, and the degradation of reception characteristics due to the effects of a CSI error may be reduced also by using the calculated reception weight vector.

Furthermore, as described also in the first embodiment, a vector at the midpoint of equivalent channel vectors of interference signals is calculated and a reception weight vector may be calculated using the vector at the midpoint. Specifically, H_{eq} is expressed as H_{eq}=[H₁′v₁ (H₂′v₂+H₃′v₃)/2] and the reception weight vector is determined to be the first row vector of H_{eq}^{H}{H_{eq}ΣH_{eq}^{H}+σ²I}⁻¹. Note that Σ is a diagonal matrix whose diagonal elements are [1 2]. Moreover, a sum vector is calculated and a reception weight vector may also be calculated not using the vector at the midpoint but using the sum vector. In this case, H_{eq} is expressed as H_{eq}=[H₁v₁ H₂′v₂+H₃′v₃] and the reception weight vector is determined to be the first row vector of H_{eq}^{H}{H_{eq}H_{eq}^{H}+σ²I}⁻¹. In this way, methods in which a vector at the midpoint of equivalent channel vectors of interference signals or a sum vector is used to calculate a reception weight vector are significantly effective as methods for reducing degradation of characteristics due to the effects of a CSI error, in the case where a leading cause that makes a CSI error occur is noise added to pilot signals in a reception device.

Moreover, the system illustrated in FIG. 6 is a target system in the present embodiment; however, the system is not limited this. The present embodiment may be applied even in the case where the number of transmission devices, which are interference sources, is increased. This is a case similar to the case where there is another transmission device, which is a transmission device 4 that transmits a signal x₄ to a reception device 4 by using a transmission weight vector v₄ in FIG. 6. Even in such a case, in the case where the reception weight vector expressed as Equation (16) is calculated, it is only necessary that an equivalent channel vector H₄′v₄ of an interference signal from the transmission device 4 be considered. Thus, the reception weight vector expressed as Equation (16) becomes (H₁′v₁)^{H}{(H₁′v₁)(H₁′v₁)^{H}+(H₂′v₂)(H₂′v₂)^{H}+(H₃′v₃)(H₃′v₃)^{H}+(H₄′v₄)(H₄′v₄)^{H}+σ²I}⁻¹.

Furthermore, as illustrated in FIG. 1, even in the case where data signals that are different from each other are received from a plurality of transmission devices, each of the data signals being received from a corresponding one of the plurality of transmission devices, the reception weight vector expressed as Equation (16) may be applied by treating, as interference signals, signals other than a desired signal that should be extracted.

The above-described two embodiments represent cases where a transmission device has a plurality of transmit antennas, precoding is performed with respect to the transmit antennas, a reception device has a plurality of receive antennas, and a desired signal is extracted by multiplying a signal received by the plurality of receive antennas and a reception weight vector together. This indicates that IA, which is used in the present invention, is performed by using a plurality of space resources (antennas). However, the methods for reducing a CSI error according to the present invention are not limited to those in which IA is performed by using a plurality of space resources and may also be applied to those in which IA is performed by using a plurality of time resources or frequency resources. For example, precoding for one data signal is performed with respect to a plurality of sub-carriers in a system in which multicarrier transmission is performed. Even in such a case, similarly to as in the case where a plurality of space resources are used, a desired signal may be extracted even under the circumstances in which a CSI error occurs, by estimating an equivalent channel vector on a precoding-by-precoding basis, by calculating a reception weight vector as expressed by Equation (16), and by multiplying a reception signal and the reception weight vector together on a precoding-by-precoding basis. Note that, similarly to as in the above-described embodiments, the number of interference signals (undesired signals) controlled on a transmission side by using IA so as to bring the equivalent channel vectors at the time of reception into alignment, in other words, the number of interference signals to be received whose equivalent channel vectors are not brought into alignment due to the effects of a CSI error is greater than or equal to the degree of freedom determined by a plurality of resources.

Moreover, the above-described two embodiments describe basic cases where devices on a transmission side are controlled so as to collaborate with one another such that the (vector) directions of the equivalent channel vectors of interference components are brought into alignment at the time of reception, the interference components coming from a plurality of transmission devices, which are the interference sources. However, in IA, it is not always necessary to bring the directions of equivalent channel vectors of interference components into alignment. This is because interference is eliminated in the case where equivalent channel vectors of interference components are controlled so as to be orthogonal to a reception weight vector. As in the above-described embodiments, for example, equivalent channel vectors of interference signals do not have to satisfy H₂v₂=kH₃v₃. In this way, in IA in the case where the directions of the equivalent channel vectors are not completely brought into alignment, the following equation needs to be satisfied.

[Math. 17]

uᵢHᵢⱼvⱼ=0 i≠j

rank(uᵢHᵢᵢvᵢ)=dₜ (17)

Here, u represents a reception weight vector, v represents a transmission weight vector, H represents a channel matrix, and d is a positive integer other than zero. The first equation of Equation (17) indicates that a signal destined for a reception device j and received by the reception device i becomes zero after the signal and a reception weight vector are multiplied together, that is, interference is eliminated. Moreover, the second equation of Equation (17) indicates that the rank (also called the stream) of a signal that is received by the reception device and that is obtained by multiplying a signal destined for the reception device i and a reception weight vector together is dᵢ, that is, a desired signal is received without being eliminated. Even though the directions of equivalent channel vectors of interference components are not brought into alignment at the time of reception, interference components may be eliminated and a desired signal may be extracted by calculating transmission weight vectors v and a reception weight vector u that satisfy the relationships indicated by Equation (17), the number of the interference components being greater than or equal to the degree of freedom. The methods for calculating such transmission weight vectors and reception weight vectors are especially effective when there are three or more transmission devices as illustrated in FIG. 6 and each of the transmission devices transmits a desired signal to a corresponding one of different destinations. However, in contrast to the case where the directions of equivalent channel vectors of interference components are controlled to be brought into alignment, it is necessary to repeat complicated calculation, and consequently, the amount of calculation is significantly increased. It is desirable that such calculation be performed in a device such as a central control section that understands all channel matrices and the like. It is necessary to notify each transmission device and each reception device of a corresponding transmission weight vector and a corresponding reception weight vector, respectively, calculated in the central control section. The transmission weight vector and the reception weight vector need to be used when the transmission device and the reception device, respectively, perform multiplication on a signal.

Even in the case where such control is performed, under the circumstances in which a CSI error occurs, it is difficult to effectively eliminate interference even when transmission weight vectors and reception weight vectors calculated by performing calculation repeatedly in the central control section are used. Thus, in each reception device, as expressed by Equation (9) or Equation (11), the effects of interference may be minimized by using a reception weight vector obtained by performing SVD on a matrix in which equivalent channel vectors of interference components are arranged, the interference components having been affected by changes in channels. Moreover, as a result of using a reception weight vector as expressed by Equation (16) obtained by solving Equation (15), a desired signal may be extracted considering not only interference but also noise.

Equation (16) represents a normal MMSE reception weight vector in the case where one desired signal and two interference signals arrive. The present invention is targeted at circumstances in which the degree of freedom is insufficient to eliminate interference and to extract a desired signal. Thus, even when the reception weight vector expressed as Equation (16) is used, it is difficult to appropriately extract a desired signal in a normal system other than IA. However, as described above, each of the equivalent channel vectors of interference signals is controlled so as to be orthogonal to a reception weight vector and to be easily eliminated on the reception side in a system in which IA is used. Thus, even when a deviation is generated for them due to a CSI error, the effects of error may be reduced and a desired signal may be extracted by using Equation (16).

Moreover, a program according to the present invention, the program being operated in a terminal device and a base station device, is a program (a program that causes a computer to realize functions) for controlling a CPU and the like such that functions of the above-described embodiments according to the present invention are realized. The information handled in these devices is stored temporarily in a RAM when being processed. Thereafter, the information is stored in various ROMs or HDDs, and is read, modified, or written as necessary by a CPU. Any of semiconductor medium (for example, ROMs, non-volatile memory cards, and the like), optical recording medium (for example, DVDs, MOs, MDs, CDs, BDs, and the like), magnetic recording medium (for example, magnetic tapes, flexible disks, and the like), and the like may be used as a recording medium in which the program is stored. There are cases where the functions of the above-described embodiment are realized by executing a loaded program. There are also cases where the functions of the present invention may be realized by performing processing together with an operating system or other application programs and the like in accordance with the instructions of the loaded program, which is being executed.

In the case where the program is put into the market, the program may be stored in portable recording mediums and then distributed or may be transferred to a server computer connected via a network such as the Internet. In this case, the memory device of the server computer is also included in the present invention. Moreover, a part of or all of terminal devices and base station devices at the above-described embodiments may be typically realized as LSI circuits, which are integrated circuits. The function blocks of the terminal devices and base station devices may be individually realized as a processor or a part of or all of them may be integrated to form a processer. In addition, the method for integrating circuits is not limited to LSI and may be realized by using dedicated circuits or general-purpose processors. In the case where a circuit-integration technology as an alternative to LSI is developed as semiconductor technology progresses, circuits may be integrated by using the circuit-integration technology.

As described above, the embodiments of the present invention have been described with reference to the drawings; however, specific structures are not limited to these embodiments. Other designs and the like that are not depart from the gist of this invention are included in the claimed inventions.

### INDUSTRIAL APPLICABILITY

The present invention is applicable to a communication device.

### REFERENCE SIGNS LIST

1-1 . . . transmission device 1, 1-2 . . . transmission device 2, 3-1 . . . reception device 1, 3-2 . . . reception device 2, 10 . . . upper layer, 11 . . . modulation unit, 12 . . . transmission weight multiplication unit, 13-1 . . . first D/A unit, 13-2 . . . second D/A unit, 14-1 . . . first wireless communication unit, 14-2 . . . second wireless communication unit, 15-1, 15-2 . . . antenna, 16 . . . pilot signal generation unit, 17 . . . transmission weight calculation unit, 18 . . . reception unit, 19 . . . A/D unit, 20 . . . third wireless communication unit, 21 . . . antenna, 30-1 to 30-3 . . . antenna, 31-1 to 31-3 . . . wireless communication unit, 32-1 to 32-3 . . . A/D unit, 33 . . . signal separation unit, 34 . . . reception weight multiplication unit, 35 . . . demodulation unit, 36 . . . upper layer, 37 . . . channel estimation unit, 38 . . . reception weight calculation unit, 39 . . . transmission unit, 40 . . . D/A unit, 41 . . . wireless communication unit, 42 . . . antenna.

The entire contents of all the publications, patents, and patent applications cited in the present specification are incorporated herein by reference.

1. A wireless communication system comprising: a plurality of transmission devices, each of which transmits signals resulting from precoding performed for a plurality of resources; and a reception device that receives at least one desired signal and a plurality of undesired signals, the number of which is greater than or equal to the degree of freedom that the plurality of resources have, the at least one desired signal and the plurality of undesired signals having been transmitted from the transmission devices, the plurality of resources being the unit of precoding,
wherein at least one of the plurality of transmission devices transmits signals on each of which precoding has been performed such that equivalent channel vectors of the plurality of undesired signals in the reception device are made to be orthogonal to a reception weight vector used in the reception device, and
wherein the reception device estimates equivalent channel vectors of the plurality of undesired signals, calculates a reception weight vector by using the estimated equivalent channel vectors of the plurality of undesired signals, and extracts a desired signal by multiplying a reception signal received using the plurality of resources and the calculated reception weight vector together, the plurality of resources being the unit of precoding.

2. The wireless communication system according to claim 1, wherein at least one of the plurality of transmission devices performs the precoding for each of the plurality of undesired signals such that the directions of the equivalent channel vectors of the plurality of undesired signals are brought into alignment in the reception device.

3. The wireless communication system according to claim 1, wherein the reception device calculates the reception weight vector by performing singular value decomposition on a matrix constituted by the equivalent channel vectors of the plurality of undesired signals.

4. The wireless communication system according to claim 2, wherein the reception device calculates the reception weight vector by performing singular value decomposition on a vector obtained by adding the equivalent channel vectors of the plurality of undesired signals.

5. The wireless communication system according to claim 3, wherein the reception device estimates an equivalent channel vector of the desired signal and calculates the reception weight vector by using, too, the equivalent channel vector of the desired signal.

6. The wireless communication system according to claim 1, wherein the reception device estimates an equivalent channel vector of the desired signal and calculates the reception weight vector by using the equivalent channel vector of the desired signal, the equivalent channel vectors of the plurality of undesired signals, and SNR in the reception device.

7. The wireless communication system according to claim 4, wherein the plurality of transmission devices transmit a channel state information estimation signal by using resources that are orthogonal to one another with respect to the plurality of transmission devices in order to estimate the equivalent channel vector of the desired signal and the equivalent channel vectors of the plurality of undesired signals in the reception device, the channel state information estimation signal having been used in the precoding.

8. A reception device to which signals are transmitted, each of which results from precoding performed for a plurality of resources in at least a part of a plurality of transmission devices such that equivalent channel vectors of undesired signals in the reception device are made to be orthogonal to a reception weight vector used in the reception device, and that receives at least one desired signal and a plurality of undesired signal, the number of which is greater than or equal to the degree of freedom that the plurality of resources have, the plurality of resources being the unit of precoding, and
wherein equivalent channel vectors of the plurality of undesired signals are estimated, a reception weight vector is calculated by using the estimated equivalent channel vectors of the plurality of undesired signals, and a desired signal is extracted by multiplying a reception signal received using the plurality of resources and the calculated reception weight vector together, the plurality of resources being the unit of precoding.

9. A transmission device that transmits signals, each of which results from precoding performed for a plurality of resources in at least a part of a plurality of transmission devices such that equivalent channel vectors of undesired signals in a reception device are made to be orthogonal to a reception weight vector used in the reception device, the reception device receiving at least one desired signal and a plurality of undesired signal, the number of which is greater than or equal to the degree of freedom that the plurality of resources have, the at least one desired signal and the plurality of undesired signals having been transmitted, the plurality of resources being the unit of precoding, and
wherein a channel state information estimation signal is transmitted by using resources that are orthogonal to one another with respect to the plurality of transmission devices in order to estimate the equivalent channel vector of the desired signal and the equivalent channel vectors of the plurality of undesired signals in the reception device, the channel state information estimation signal having been used in the precoding.
